(19) United States
(12) Patent Application Publication
(10) Pub. No.: US 2019/0164007 A1
(43) Pub. Date: May 30, 2019

(54) HUMAN DRIVING BEHAVIOR MODELING SYSTEM USING MACHINE LEARNING

(71) Applicant: TuSimple, San Diego, CA (US)

(72) Inventors: Liu LIU, San Diego, CA (US); Yiqian GAN, San Diego, CA (US)

(21) Appl. No.: 16/120,247

(22) Filed: Sep. 1, 2018

Related U.S. Application Data
(63) Continuation-in-part of application No. 15/827,452, filed on Nov. 30, 2017.

(51) Int. Cl. G06K 9/62; G05D 1/00; G06K 9/00

(52) U.S. Cl. CPC G06K 9/627; G05D 1/0088; G06K 2209/23; G06K 9/00785; G06K 9/0063

(57) ABSTRACT

A human driving behavior modeling system using machine learning is disclosed. A particular embodiment can be configured to: obtain training image data from a plurality of real world image sources and perform object extraction on the training image data to detect a plurality of vehicle objects in the training image data; categorize the detected plurality of vehicle objects into behavior categories based on vehicle objects performing similar maneuvers at similar locations of interest; train a machine learning module to model particular human driving behaviors based on use of the training image data from one or more corresponding behavior categories; and generate a plurality of simulated dynamic vehicles that each model one or more of the particular human driving behaviors trained into the machine learning module based on the training image data.

### PRIORITY PATENT APPLICATION

This is a continuation-in-part (CIP) patent application drawing priority from U.S. non-provisional patent application Ser. No. 15/827,452; filed Nov. 30, 2017. This present non-provisional CIP patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2017-2018, TuSimple, All Rights Reserved.

### TECHNICAL FIELD

This patent document pertains generally to tools (systems, apparatuses, methodologies, computer program products, etc.) for autonomous driving simulation systems, trajectory planning, vehicle control systems, and autonomous driving systems, and more particularly, but not by way of limitation, to a human driving behavior modeling system using machine learning.

### BACKGROUND

An autonomous vehicle is often configured to follow a trajectory based on a computed driving path generated by a motion planner. However, when variables such as obstacles (e.g., other dynamic vehicles) are present on the driving path, the autonomous vehicle must use its motion planner to modify the computed driving path and perform corresponding control operations so the vehicle may be safely driven by changing the driving path to avoid the obstacles. Motion planners for autonomous vehicles can be very difficult to build and configure. The logic in the motion planner must be able to anticipate, detect, and react to a variety of different driving scenarios, such as the actions of the dynamic vehicles in proximity to the autonomous vehicle. In most cases, it is not feasible and even dangerous to test autonomous vehicle motion planners in real world driving environments. As such, simulators can be used to test autonomous vehicle motion planners. However, to be effective in testing autonomous vehicle motion planners, these simulators must be able to realistically model the behaviors of the simulated dynamic vehicles in proximity to the autonomous vehicle in a variety of different driving or traffic scenarios.

Simulation plays a vital role when developing autonomous vehicle systems. Instead of testing on real roadways, autonomous vehicle subsystems, such as motion planning systems, should be frequently tested in a simulation environment in the autonomous vehicle subsystem development and deployment process. One of the most important features of the simulation that can determine the level of fidelity of the simulation environment is NPC (non-player-character) Artificial Intelligence (AI) and the related behavior of NPCs or simulated dynamic vehicles in the simulation environment. The goal is to create a simulation environment wherein the NPC performance and behaviors closely correlate to the corresponding behaviors of human drivers. It is important to create a simulation environment that is as realistic as possible compared to human drivers, so the autonomous vehicle subsystems (e.g., motion planning systems) run against the simulation environment can be effectively and efficiently improved using simulation.

In the development of traditional video games, for example, AI is built into the video game using rule-based methods. In other words, the game developer will first build some simple action models for the game (e.g., lane changing models, lane following models, etc.). Then, the game developer will try to enumerate most of the decision cases, which humans would make under conditions related to the action models. Next, the game developer will program all of these enumerated decisions (rules) into the model to complete the overall AI behavior of the game. The advantage of this rule-based method is the quick development time, and the fairly accurate interpretation of human driving behavior. However, the disadvantage is that rule-based methods are a very subjective interpretation of how humans drive. In other words, different engineers will develop different models based on their own driving habits. As such, rule-based methods for autonomous vehicle simulation do not provide a realistic and consistent simulation environment.

Conventional simulators have been unable to overcome the challenges of modeling human driving behaviors of the NPCs (e.g., simulated dynamic vehicles) to make the behaviors of the NPCs as similar to real human driver behaviors as possible. Moreover, conventional simulators have been unable to achieve a level of efficiency and capacity necessary to provide an acceptable test tool for autonomous vehicle subsystems.

### SUMMARY

A human driving behavior modeling system using machine learning is disclosed herein. Specifically, the present disclosure describes an autonomous vehicle simulation system that uses machine learning to generate data corresponding to simulated dynamic vehicles having various real world driving behaviors to test, evaluate, or otherwise analyze autonomous vehicle subsystems (e.g., motion planning systems), which can be used in real autonomous vehicles in actual driving environments. The simulated dynamic vehicles (also denoted herein as non-player characters or NPC vehicles) generated by the human driving behavior or vehicle modeling system of various example embodiments described herein can model the vehicle behaviors that would be performed by actual vehicles in the real world, including lane change, overtaking, acceleration behaviors, and the like. The vehicle modeling system described herein can reconstruct or model high fidelity traffic scenarios with various driving behaviors using a data-driven method instead of rule-based methods.

In various example embodiments disclosed herein, a human driving behavior modeling system or vehicle modeling system uses machine learning with different sources of data to create simulated dynamic vehicles that are able to mimic different human driving behaviors. Training image data for the machine learning module of the vehicle modeling system comes from, but is not limited to: video footage recorded by on-vehicle cameras, images from stationary cameras on the sides of roadways, images from cameras positioned in unmanned aerial vehicles (UAVs or drones) hovering above a roadway, satellite images, simulated images, previously-recorded images, and the like. After the vehicle modeling system acquires the training image data, the first step is to perform object detection and to extract vehicle objects from the input image data. Semantic segmentation, among other techniques, can be used for the vehicle object extraction process. For each detected vehicle object in the image data, the motion and trajectory of the detected vehicle object can be tracked across multiple image frames. The geographical location of each of the detected vehicle objects can also be determined based on the source of the image, the view of the camera sourcing the image, and an area map of a location of interest. Each detected vehicle object can be labeled with its own identifier, trajectory data, and location data. Then, the vehicle modeling system can categorize the detected and labeled vehicle objects into behavior groups or categories for training. For example, the detected vehicle objects performing similar maneuvers at particular locations of interest can be categorized into various behavior groups or categories. The particular vehicle maneuvers or behaviors can be determined based on the vehicle object's trajectory and location data determined as described above. For example, vehicle objects that perform similar turning, merging, stopping, accelerating, or passing maneuvers can be grouped together into particular behavior categories. Vehicle objects that operate in similar locations or traffic areas (e.g., freeways, narrow roadways, ramps, hills, tunnels, bridges, carpool lanes, service areas, toll stations, etc.) can be grouped together into particular behavior categories. Vehicle objects that operate in similar traffic conditions (e.g., normal flow traffic, traffic jams, accident scenarios, road construction, weather or night conditions, animal or obstacle avoidance, etc.) can be grouped together into other behavior categories. Vehicle objects that operate in proximity to other specialized vehicles (e.g., police vehicles, fire vehicles, ambulances, motorcycles, limosines, extra wide or long trucks, disabled vehicles, erratic vehicles, etc.) can be grouped together into other behavior categories. It will be apparent to those of ordinary skill in the art in view of the disclosure herein that a variety of particular behavior categories can be defined and associated with behaviors detected in the vehicle objects extracted from the input images.

Once the training image data is processed and categorized as described above, the machine learning module of the vehicle modeling system can be specifically trained to model a particular human driving behavior based on the use of training images from a corresponding behavior category. For example, the machine learning module can be trained to recreate or model the typical human driving behavior associated with a ramp merge-in situation. Given the training image vehicle object extraction and vehicle behavior categorization process as described above, a plurality of vehicle objects performing ramp merge-in maneuvers will be members of the corresponding behavior category associated with the ramp merge-in situation. The machine learning module can be specifically trained to model these particular human driving behaviors based on the maneuvers performed by the members of the corresponding behavior category. Similarly, the machine learning module can be trained to recreate or model the typical human driving behavior associated with any of the driving behavior categories as described above. As such, the machine learning module of the vehicle modeling system can be trained to model a variety of specifically targeted human driving behaviors, which in the aggregate represent a model of typical human driving behaviors in a variety of different driving scenarios and conditions.

Once the machine learning module is trained as described above, the trained machine learning module can be used with the vehicle modeling system to generate a plurality of simulated dynamic vehicles that each mimic one or more of the specific human driving behaviors trained into the machine learning module based on the training image data. The plurality of simulated dynamic vehicles can be used in a driving environment simulator as a testbed against which an autonomous vehicle subsystem (e.g., a motion planning system) can be tested. Because the behavior of the simulated dynamic vehicles is based on the corresponding behavior of real world vehicles captured in the training image data, the driving environment created by the driving environment simulator is much more realistic and authentic than a rule-based simulator. By use of the trained machine learning module, the driving environment simulator can create simulated dynamic vehicles that mimic actual human driving behaviors when, for example, the simulated dynamic vehicle drives near a highway ramp, gets stuck in a traffic jam, drives in a construction zone at night, or passes a truck or a motorcycle. Some of the simulated dynamic vehicles will stay in one lane, others will try to change lanes whenever possible, just as a human driver would do. The driving behaviors exhibited by the simulated dynamic vehicles will originate from the processed training image data, instead of the driving experience of programmers who code rules into conventional simulation systems. In general, the trained machine learning module and the driving environment simulator of the various embodiments described herein can model real world human driving behaviors, which can be recreated in simulation and used in the driving environment simulator for testing autonomous vehicle subsystem (e.g., a motion planning system). Details of the various example embodiments are described below.

### BRIEF DESCRIPTION OF THE DRAWINGS

The various embodiments are illustrated by way of example, and not by way of limitation, in the figures of the accompanying drawings in which:

FIG. 1 illustrates the basic components of an autonomous vehicle simulation system of an example embodiment and the interaction of the autonomous vehicle simulation system with real world image and map data sources, the autonomous vehicle simulation system including a vehicle modeling system to generate simulated dynamic vehicle data for use by a driving environment simulator;

FIGS. 2 and 3 illustrate the processing performed by the vehicle modeling system of an example embodiment to generate simulated dynamic vehicle data for use by the driving environment simulator;

FIG. 4 is a process flow diagram illustrating an example embodiment of the vehicle modeling and simulation system; and

FIG. 5 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A human driving behavior modeling system using machine learning is disclosed herein. Specifically, the present disclosure describes an autonomous vehicle simulation system that uses machine learning to generate data corresponding to simulated dynamic vehicles having various driving behaviors to test, evaluate, or otherwise analyze autonomous vehicle subsystems (e.g., motion planning systems), which can be used in real autonomous vehicles in actual driving environments. The simulated dynamic vehicles (also denoted herein as non-player characters or NPC vehicles) generated by the human driving behavior or vehicle modeling system of various example embodiments described herein can model the vehicle behaviors that would be performed by actual vehicles in the real world, including lane change, overtaking, acceleration behaviors, and the like. The vehicle modeling system described herein can reconstruct or model high fidelity traffic scenarios with various driving behaviors using a data-driven method instead of rule-based methods.

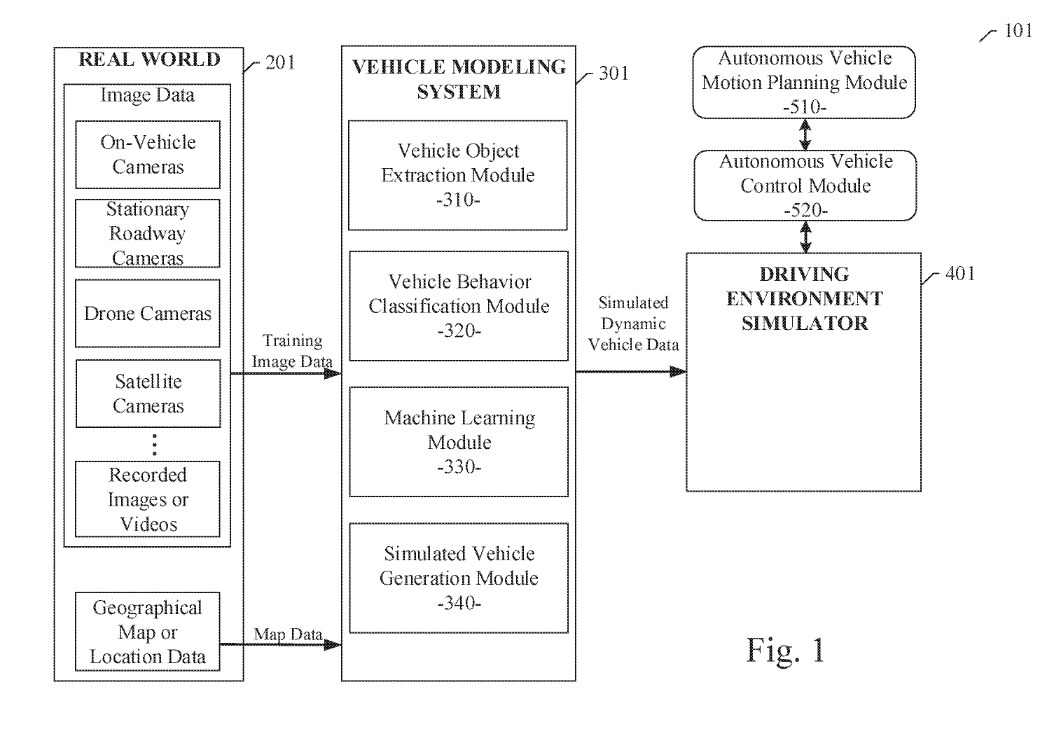

Referring to FIG. 1, the basic components of an autonomous vehicle simulation system 101 of an example embodiment are illustrated. FIG. 1 also shows the interaction of the autonomous vehicle simulation system 101 with real world image and map data sources 201. In an example embodiment, the autonomous vehicle simulation system 101 includes a vehicle modeling system 301 to generate simulated dynamic vehicle data for use by a driving environment simulator 401. The details of the vehicle modeling system 301 of an example embodiment are provided below. The driving environment simulator 401 can use the simulated dynamic vehicle data generated by the vehicle modeling system 301 to create a simulated driving environment in which various autonomous vehicle subsystems (e.g., autonomous vehicle motion planning module 510, autonomous vehicle control module 520, etc.) can be analyzed and tested against various driving scenarios. The autonomous vehicle motion planning module 510 can use map data and perception data to generate a trajectory and acceleration/speed for a simulated autonomous vehicle that transitions the vehicle toward a desired destination while avoiding obstacles, including other proximate simulated dynamic vehicles. The autonomous vehicle control module 520 can use the trajectory and acceleration/speed information generated by the motion planning module 510 to generate autonomous vehicle control messages that can manipulate the various control subsystems in an autonomous vehicle, such as throttle, brake, steering, and the like. The manipulation of the various control subsystems in the autonomous vehicle can cause the autonomous vehicle to traverse the trajectory with the acceleration/speed as generated by the motion planning module 510. The use of motion planners and control modules in autonomous vehicles is well-known to those of ordinary skill in the art. Because the simulated dynamic vehicles generated by the vehicle modeling system 301 mimic real world human driving behaviors, the simulated driving environment created by the driving environment simulator 401 represents a realistic, real world environment for effectively testing autonomous vehicle subsystems.

Referring still to FIG. 1, the autonomous vehicle simulation system 101 includes the vehicle modeling system 301. In various example embodiments disclosed herein, the vehicle modeling system 301 uses machine learning with different sources of data to create simulated dynamic vehicles that are able to mimic different human driving behavior. In an example embodiment, the vehicle modeling system 301 can include a vehicle object extraction module 310, a vehicle behavior classification module 320, a machine learning module 330, and a simulated vehicle generation module 340. Each of these modules can be implemented as software components executing within an executable environment of the vehicle modeling system 301 operating on computing system or data processing system. Each of these modules of an example embodiment is described in more detail below in connection with the figures provided herein.

Referring still to FIG. 1, the vehicle modeling system 301 of an example embodiment can include a vehicle object extraction module 310. In the example embodiment, the vehicle object extraction module 310 can receive training image data for the machine learning module 330 from a plurality of real world image data sources 201. In the example embodiment, the real world image data sources 201 can include, but are not limited to: video footage recorded by on-vehicle cameras, images from stationary cameras on the sides of roadways, images from cameras positioned in unmanned aerial vehicles (UAVs or drones) hovering above a roadway, satellite images, simulated images, previously-recorded images, and the like. The image data collected from the real world data sources 201 reflects truly realistic, real-world traffic environment image data related to the locations or routings, the scenarios, and the driver behaviors being monitored by the real world data sources 201. Using the standard capabilities of well-known data collection devices, the gathered traffic and vehicle image data and other perception or sensor data can be wirelessly transferred (or otherwise transferred) to a data processor of a computing system or data processing system, upon which the vehicle modeling system 301 can be executed. Alternatively, the gathered traffic and vehicle image data and other perception or sensor data can be stored in a memory device at the monitored location or in the test vehicle and transferred later to the data processor of the computing system or data processing system. The traffic and vehicle image data and other perception or sensor data, gathered or calculated by the vehicle object extraction module 310 can be used to train the machine learning module 330 to generate simulated dynamic vehicles for the driving environment simulator 401 as described in more detail below.

After the vehicle object extraction module 310 acquires the training image data from the real world image data sources 201, the next step is to perform object detection and to extract vehicle objects from the input image data. Semantic segmentation, among other techniques, can be used for the vehicle object extraction process. For each detected vehicle object in the image data, the motion and trajectory of the detected vehicle object can be tracked across multiple image frames. The vehicle object extraction module 310 can also receive geographical location or map data corresponding to each of the detected vehicle objects. The geographical location or map data can be determined based on the source of the corresponding image data, the view of the camera sourcing the image, and an area map of a location of interest. Each vehicle object detected by the vehicle object extraction module 310 can be labeled with its own identifier, trajectory data, location data, and the like.

The vehicle modeling system 301 of an example embodiment can include a vehicle behavior classification module 320. The vehicle behavior classification module 320 can be configured to categorize the detected and labeled vehicle objects into groups or behavior categories for training the machine learning module 330. For example, the detected vehicle objects performing similar maneuvers at particular locations of interest can be categorized into various behavior groups or categories. The particular vehicle maneuvers or behaviors can be determined based on the detected vehicle object's trajectory and location data determined as described above. For example, vehicle objects that perform similar turning, merging, stopping, accelerating, or passing maneuvers can be grouped together into particular behavior categories by the vehicle behavior classification module 320. Vehicle objects that operate in similar locations or traffic areas (e.g., freeways, narrow roadways, ramps, hills, tunnels, bridges, carpool lanes, service areas, toll stations, etc.) can be grouped together into other behavior categories. Vehicle objects that operate in similar traffic conditions (e.g., normal flow traffic, traffic jams, accident scenarios, road construction, weather or night conditions, animal or obstacle avoidance, etc.) can be grouped together into other behavior categories. Vehicle objects that operate in proximity to other specialized vehicles (e.g., police vehicles, fire vehicles, ambulances, motorcycles, limosines, extra wide or long trucks, disabled vehicles, erratic vehicles, etc.) can be grouped together into other behavior categories. It will be apparent to those of ordinary skill in the art in view of the disclosure herein that a variety of particular behavior categories can be defined and associated with behaviors detected in the vehicle objects extracted from the input images. As such, the vehicle behavior classification module 320 can be configured to build a plurality of vehicle behavior classifications or behavior categories that each represent a particular behavior or driving scenario associated with the detected vehicle objects from the training image data. These behavior categories can be used for training the machine learning module 330 and for enabling the driving environment simulator 401 to independently test specific vehicle/driving behaviors or driving scenarios.

The vehicle modeling system 301 of an example embodiment can include a machine learning module 330. Once the training image data is processed and categorized as described above, the machine learning module 330 of the vehicle modeling system 301 can be specifically trained to model a particular human driving behavior based on the use of training images from a corresponding behavior category. For example, the machine learning module 330 can be trained to recreate or model the typical human driving behavior associated with a ramp merge-in situation. Given the training image vehicle object extraction and vehicle behavior categorization process as described above, a plurality of vehicle objects performing ramp merge-in maneuvers will be members of the corresponding behavior category associated with a ramp merge-in situation, or the like. The machine learning module 330 can be specifically trained to model these particular human driving behaviors based on the maneuvers performed by the members (e.g., the detected vehicle objects from the training image data) of the corresponding behavior category. Similarly, the machine learning module 330 can be trained to recreate or mimic the typical human driving behavior associated with any of the driving behavior categories as described above. As such, the machine learning module 330 of the vehicle modeling system 301 can be trained to model a variety of specifically targeted human driving behaviors, which in the aggregate represent a model of typical human driving behaviors in a variety of different driving scenarios and conditions.

Referring still to FIG. 1, the vehicle modeling system 301 of an example embodiment can include a simulated vehicle generation module 340. Once the machine learning module 330 is trained as described above, the trained machine learning module 330 can be used with the simulated vehicle generation module 340 to generate a plurality of simulated dynamic vehicles that each mimic one or more of the specific human driving behaviors trained into the machine learning module 330 based on the training image data. For example, a particular simulated dynamic vehicle can be generated by the simulated vehicle generation module 340, wherein the generated simulated dynamic vehicle models a specific driving behavior corresponding to one or more of the behavior classifications or categories (e.g., vehicle/driver behavior categories related to traffic areas/locations, vehicle/driver behavior categories related to traffic conditions, vehicle/driver behavior categories related to special vehicles, or the like). The simulated dynamic vehicles generated by the simulated vehicle generation module 340 can include trajectories, speed profiles, heading profiles, locations, and other data for defining a behavior for each of the plurality of simulated dynamic vehicles. Data corresponding to the plurality of simulated dynamic vehicles can be output to and used by the driving environment simulator 401 as a traffic environment testbed against which various autonomous vehicle subsystems (e.g., autonomous vehicle motion planning module 510, autonomous vehicle control module 520, etc.) can be tested, evaluated, and analyzed. Because the behavior of the simulated dynamic vehicles generated by the simulated vehicle generation module 340 is based on the corresponding behavior of real world vehicles captured in the training image data, the driving environment created by the driving environment simulator 401 is much more realistic and authentic than a rules-based simulator. By use of the vehicle modeling system 301 and the trained machine learning module 330 therein, the driving environment simulator 401 can incorporate the simulated dynamic vehicles into the traffic environment testbed, wherein the simulated dynamic vehicles will mimic actual human driving behaviors when, for example, the simulated dynamic vehicle drives near a highway ramp, gets stuck in a traffic jam, drives in a construction zone at night, or passes a truck or a motorcycle. Some of the simulated dynamic vehicles will stay in one lane, others will try to change lanes whenever possible, just as a human driver would do. The driving behaviors exhibited by the simulated dynamic vehicles generated by the simulated vehicle generation module 340 will originate from the processed training image data, instead of the driving experience of programmers who code rules into conventional simulation systems. In general, the vehicle modeling system 301 with the trained machine learning module 330 therein and the driving environment simulator 401 of the various embodiments described herein can model real world human driving behaviors, which can be recreated or modeled in simulation and used in the driving environment simulator 401 for testing autonomous vehicle subsystem (e.g., a motion planning system).

Referring again to FIG. 1, the vehicle modeling system 301 and the driving environment simulator 401 can be configured to include executable modules developed for execution by a data processor in a computing environment of the autonomous vehicle simulation system 101. In the example embodiment, the vehicle modeling system 301 can be configured to include the plurality of executable modules as described above. A data storage device or memory can also be provided in the autonomous vehicle simulation system 101 of an example embodiment. The memory can be implemented with standard data storage devices (e.g., flash memory, DRAM, SIM cards, or the like) or as cloud storage in a networked server. In an example embodiment, the memory can be used to store the training image data, data related to the driving behavior categories, data related to the simulated dynamic vehicles, and the like as described above. In various example embodiments, the plurality of simulated dynamic vehicles can be configured to simulate more than the typical driving behaviors. To simulate an environment that is identical to the real world as much as possible, the simulated vehicle generation module 340 can generate simulated dynamic vehicles that represent typical driving behaviors, which represent average drivers. Additionally, the simulated vehicle generation module 340 can generate simulated dynamic vehicles that represent atypical driving behaviors. In most cases, the trajectories corresponding to the plurality of simulated dynamic vehicles include typical and atypical driving behaviors. As a result, autonomous vehicle motion planners 510 and/or autonomous vehicle control modules 520 can be stimulated by the driving environment simulator 401 using trajectories generated to correspond to the driving behaviors of polite and impolite drivers as well as patient and impatient drivers in the virtual world. In all, the simulated dynamic vehicles can be configured with data representing driving behaviors that are as varied as possible.

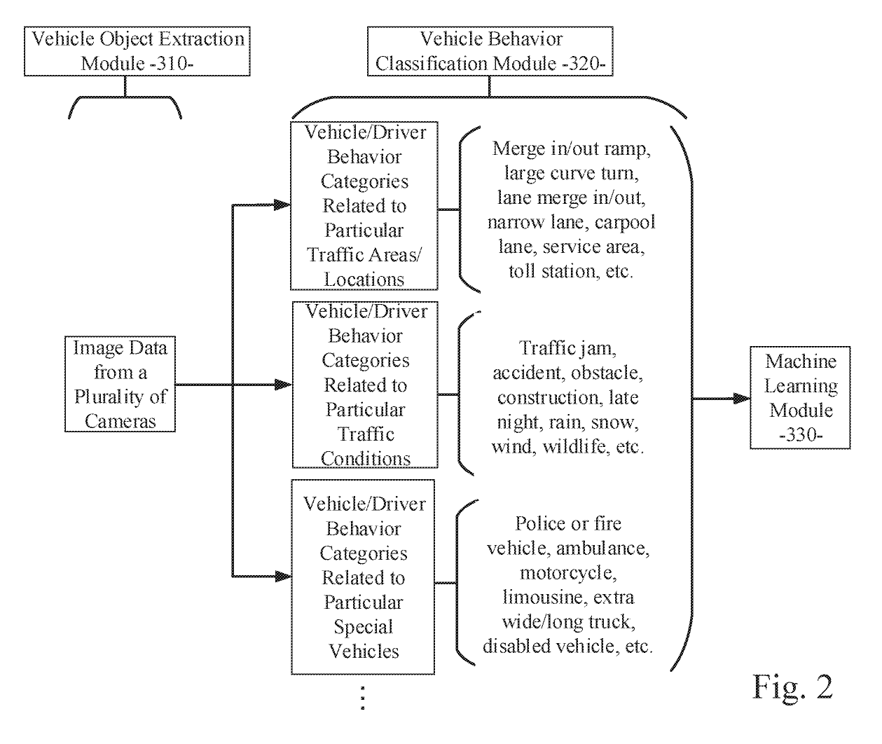

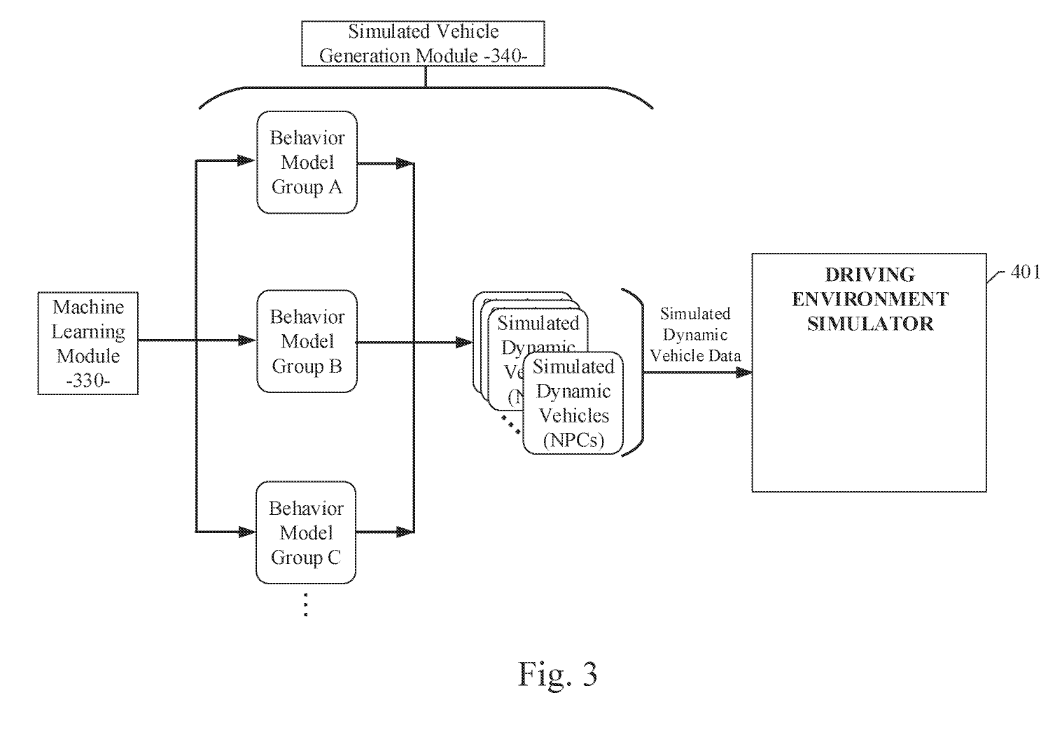

Referring now to FIGS. 2 and 3, the processing performed by the vehicle modeling system 301 of an example embodiment for generating simulated dynamic vehicle data for use by the driving environment simulator 401 is illustrated. As shown in FIG. 2, the vehicle object extraction module 310 can obtain training image data from a plurality of image sources, such as cameras. The vehicle object extraction module 310 can further perform object extraction on the training image data to identify or detect vehicle objects in the image data. The detected vehicle objects can include a trajectory and location of each vehicle object. The vehicle behavior classification module 320 can use the trajectory and location data for each of the detected vehicle objects to generate a plurality of vehicle/driver behavior categories related to similar vehicle object maneuvers. For example, the detected vehicle objects performing similar maneuvers at particular locations of interest can be categorized into various behavior groups or categories. The particular vehicle maneuvers or behaviors can be determined based on the detected vehicle object's trajectory and location data determined as described above. In an example embodiment shown in FIG. 2, the various behavior groups or categories can include vehicle/driver behavior categories related to traffic areas/locations, vehicle/driver behavior categories related to traffic conditions, vehicle/driver behavior categories related to special vehicles, or the like. The vehicle behavior classification module 320 can be configured to build a plurality of vehicle behavior classifications or behavior categories that each represent a particular behavior or driving scenario associated with the detected vehicle objects from the training image data. These behavior categories be used for training the machine learning module 330 and for enabling the driving environment simulator 401 to independently test specific vehicle/driving behaviors or driving scenarios.

Referring now to FIG. 3, after the machine learning module 330 is trained as described above, the trained machine learning module 330 can be used with the simulated vehicle generation module 340 to generate a plurality of simulated dynamic vehicles that each mimic one or more of the specific human driving behaviors trained into the machine learning module 330 based on the training image data. The plurality of vehicle behavior classifications or behavior categories that each represent a particular behavior or driving scenario can be associated with a grouping of corresponding detected vehicle objects. The behaviors of these detected vehicle objects in each of the vehicle behavior classifications can be used to generate the plurality of corresponding simulated dynamic vehicles or NPCs. Data corresponding to these simulated dynamic vehicles can be provided to the driving environment simulator 401. The driving environment simulator 401 can incorporate the simulated dynamic vehicles into the traffic environment testbed, wherein the simulated dynamic vehicles will mimic actual human driving behaviors for testing autonomous vehicle subsystems.

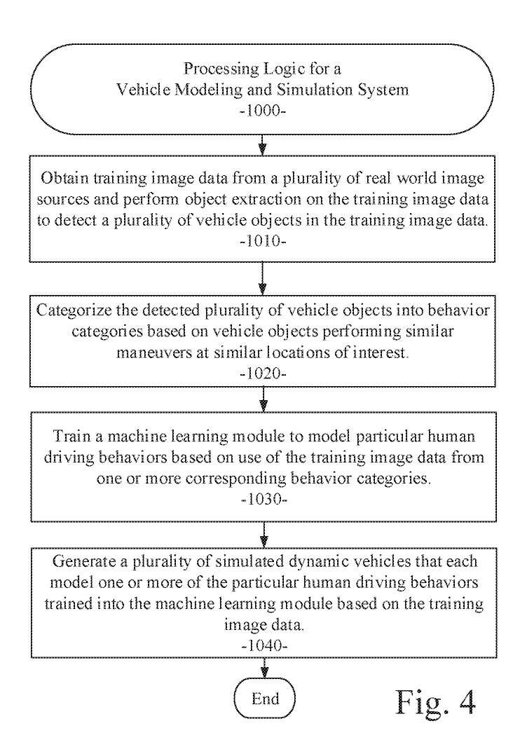

Referring now to FIG. 4, a flow diagram illustrates an example embodiment of a system and method 1000 for vehicle modeling and simulation. The example embodiment can be configured to: obtain training image data from a plurality of real world image sources and perform object extraction on the training image data to detect a plurality of vehicle objects in the training image data (processing block 1010); categorize the detected plurality of vehicle objects into behavior categories based on vehicle objects performing similar maneuvers at similar locations of interest (processing block 1020); train a machine learning module to model particular human driving behaviors based on use of the training image data from one or more corresponding behavior categories (processing block 1030); and generate a plurality of simulated dynamic vehicles that each model one or more of the particular human driving behaviors trained into the machine learning module based on the training image data (processing block 1040).

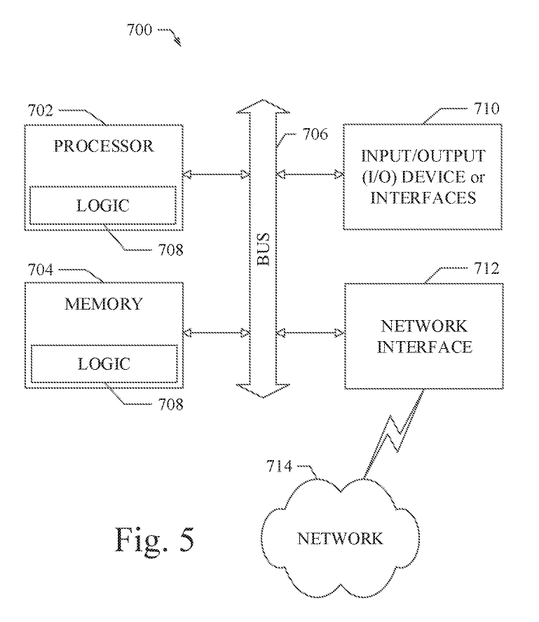

FIG. 5 shows a diagrammatic representation of a machine in the example form of a computing system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example computing system 700 can include a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, a voice interface, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication and data processing mechanisms by which information/data may travel between a computing system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor;
a vehicle object extraction module, executable by the data processor, to obtain training image data from a plurality of real world image sources and to perform object extraction on the training image data to detect a plurality of vehicle objects in the training image data;
a vehicle behavior classification module, executable by the data processor, to categorize the detected plurality of vehicle objects into behavior categories based on vehicle objects performing similar maneuvers at similar locations of interest;
a machine learning module, executable by the data processor, trained to model particular human driving behaviors based on use of the training image data from one or more corresponding behavior categories; and
a simulated vehicle generation module, executable by the data processor, to generate a plurality of simulated dynamic vehicles that each model one or more of the particular human driving behaviors trained into the machine learning module based on the training image data.

2. The system of claim 1 being further configured to include a driving environment simulator to incorporate the plurality of simulated dynamic vehicles into a traffic environment testbed for testing, evaluating, or analyzing autonomous vehicle subsystems.

3. The system of claim 1 wherein the plurality of real world image sources are from the group consisting of: on-vehicle cameras, stationary cameras, cameras in unmanned aerial vehicles (UAVs or drones), satellite images, simulated images, and previously-recorded images.

4. The system of claim 1 wherein the object extraction performed on the training image data is performed using semantic segmentation.

5. The system of claim 1 wherein the object extraction performed on the training image data includes determining a trajectory for each of the plurality of vehicle objects.

6. The system of claim 1 wherein the behavior categories are from the group consisting of: vehicle/driver behavior categories related to traffic areas/locations, vehicle/driver behavior categories related to traffic conditions, and vehicle/driver behavior categories related to special vehicles.

7. The system of claim 2 wherein the autonomous vehicle subsystems are from the group consisting of: an autonomous vehicle motion planning module, and an autonomous vehicle control module.

8. A method comprising:
using a data processor to obtain training image data from a plurality of real world image sources and using the data processor to perform object extraction on the training image data to detect a plurality of vehicle objects in the training image data;
using the data processor to categorize the detected plurality of vehicle objects into behavior categories based on vehicle objects performing similar maneuvers at similar locations of interest;
training a machine learning module to model particular human driving behaviors based on use of the training image data from one or more corresponding behavior categories; and
using the data processor to generate a plurality of simulated dynamic vehicles that each model one or more of the particular human driving behaviors trained into the machine learning module based on the training image data.

9. The method of claim 8 including incorporating the plurality of simulated dynamic vehicles into a driving environment simulator for testing, evaluating, or analyzing autonomous vehicle subsystems.

10. The method of claim 8 wherein the plurality of real world image sources are from the group consisting of: on-vehicle cameras, stationary cameras, cameras in unmanned aerial vehicles (UAVs or drones), satellite images, simulated images, and previously-recorded images.

11. The method of claim 8 wherein the object extraction performed on the training image data is performed using semantic segmentation.

12. The method of claim 8 wherein the object extraction performed on the training image data includes determining a trajectory for each of the plurality of vehicle objects.

13. The method of claim 8 wherein the behavior categories are from the group consisting of: vehicle/driver behavior categories related to traffic areas/locations, vehicle/driver behavior categories related to traffic conditions, and vehicle/driver behavior categories related to special vehicles.

14. The method of claim 9 wherein the autonomous vehicle subsystems are from the group consisting of: an autonomous vehicle motion planning module, and an autonomous vehicle control module.

15. A non-transitory machine-useable storage medium embodying instructions which, when executed by a machine, cause the machine to:
a vehicle object extraction module, executable by the data processor, to obtain training image data from a plurality of real world image sources and to perform object extraction on the training image data to detect a plurality of vehicle objects in the training image data;
a vehicle behavior classification module, executable by the data processor, to categorize the detected plurality of vehicle objects into behavior categories based on vehicle objects performing similar maneuvers at similar locations of interest;
a machine learning module, executable by the data processor, trained to model particular human driving behaviors based on use of the training image data from one or more corresponding behavior categories; and
a simulated vehicle generation module, executable by the data processor, to generate a plurality of simulated dynamic vehicles that each model one or more of the particular human driving behaviors trained into the machine learning module based on the training image data.

16. The non-transitory machine-useable storage medium of claim 15 being further configured to include a driving environment simulator to incorporate the plurality of simulated dynamic vehicles into a traffic environment testbed for testing, evaluating, or analyzing autonomous vehicle subsystems.

17. The non-transitory machine-useable storage medium of claim 15 wherein the plurality of real world image sources are from the group consisting of: on-vehicle cameras, stationary cameras, cameras in unmanned aerial vehicles (UAVs or drones), satellite images, simulated images, and previously-recorded images.

18. The non-transitory machine-useable storage medium of claim 15 wherein the object extraction performed on the training image data is performed using semantic segmentation.

19. The non-transitory machine-useable storage medium of claim 15 wherein the object extraction performed on the training image data includes determining a trajectory for each of the plurality of vehicle objects.

20. The non-transitory machine-useable storage medium of claim 15 wherein the behavior categories are from the group consisting of: vehicle/driver behavior categories related to traffic areas/locations, vehicle/driver behavior categories related to traffic conditions, and vehicle/driver behavior categories related to special vehicles.
